(19) United States
(12) Patent Application Publication
(10) Pub. No.: US 2014/0080464 A1
(43) Pub. Date: Mar. 20, 2014

(54) CALL INITIATION SYSTEM AND METHOD

(71) Applicant: Zeev Kotzer, Haifa (IL)

(72) Inventor: Zeev Kotzer, Haifa (IL)

(73) Assignee: PASSCALL ADVANCED TECHNOLOGIES (TRANSFORMA) LTD., Haifa (IL)

(21) Appl. No.: 14/111,750

(22) PCT Filed: Apr. 5, 2012
(86) PCT No.: PCT/IL12/50133

§ 371 Date: Nov. 11, 2013

(30) Foreign Application Priority Data
Apr. 14, 2011 (IL) 212360

(51) Int. Cl. H04M 3/42

(52) U.S. Cl. CPC H04M 3/42102
USPC 455/414.1

(57) ABSTRACT

The invention relates to telephony services. More specifically, to call initiation according to contact information captured from a display on computer screens. The distributed telephony system comprises a contact recognition component capable of being installed on end-user communication devices, the devices allowing access to information displayed on a screen, and capable of extracting target contact information from data presented on said screen; a calling media selection component capable of selecting source end-user communication devices and communication IDs, the communication IDs representing target end-user communication devices corresponding with the target contact information; and a call generation component capable of generating connections from the source end-user communication devices to the target end-user communication devices.

### FIELD OF THE INVENTION

The present invention relates to telephony services. More specifically, the invention relates to call initiation according to contact information which is captured from a display on computer screens.

### BACKGROUND

Computerized environments enable users to locate contact information of businesses, services and individuals. The contact information may be located in private (personal or business owned) document depositories, or in public data stores such as the internet. Contact information is typically displayed on a screen of a computer, a smart phone, a PDA, or any other device which may be used to access and display data.

Initiating a phone call according to contact information displayed on a screen is not an effortless process. Traditionally, the user was required to select the calling media through which he wants to initiate a call, for example his line or mobile phone, copy a phone number as displayed to the media of his choice and initiate the call. The manual process of copying a telephone number is cumbersome, time consuming and prone to errors. The transfer of the number as displayed to the calling media may require modification such as adding (or deleting) area code, adding access code or replacing some of the digits. For example, the “+” sign may need to be replaced with the proper international access code and alphabet symbols may need to be replaced with their numerical equivalents. The calling media often facilitates a selection among different billing schemes and/or different communication channels offering different prices and/or line quality, however these considerations are not often taken into account by a typical user.

Large organizations utilize CRM-PBX systems, which integrate Customer Relationship Management (CRM) software along with Private Branch Exchange (PBX) solutions to facilitate direct call initiation to individuals registered within such systems, individuals such as company employees, partners and customers.

PBX solutions enable external line sharing by a plurality of employees and optimization of outgoing calls according to the organizational preferences. These solutions, however, serve a particular business or office and are not available to the general public. CRM software enables quick dialing to registered individuals via a corporate exchange, but does not address copying contact information of new and unknown businesses and individuals which may appear on screens for example as a result of a particular business search on the internet or contact information received via e-mail.

US Patent Application Publication No. 2004/0247099 titled “Method for automatically dialing a telephone number” to Brun and Filoux describes a method applicable to computer-assisted telephony of automatically dialing a telephone number from a string of characters found in a document displayed on a computer screen using Optical Character Recognition (OCR). This method requires that a user designates the zone on the screen that displays the string of characters representing the contact. The method enables recognition of characters which can be found in graphic formats such as received via fax communication, and converting these characters to their corresponding digital encoding. The method further mentions consulting with an electronic directory to determine a telephone number corresponding to a name in the directory.

U.S. Pat. No. 5,903,631 titled “One-button Intelligent CTI dialer” to Mitel Corporation describes a method and apparatus for dialing a phone number displayed within a screen image generated by software applications executed on a computer connected to a phone device having a dial button. The application focuses on locating a phone number on a screen image and transmitting the phone number to a phone device capable of performing a dial operation.

In most cases, an analog line must be available for use, which is not relevant for mobile users and hardly the case for many corporate users utilizing digital PBX solutions. Analog modem installations on the computer initiating the call are rare nowadays. Furthermore, these patents do not address the end-to-end scenario of recognizing contact information upon a screen and initiating calls based on the optimal preferences for a user.

### SUMMARY OF THE EMBODIMENTS

The present invention relates to telephony services. More specifically, to call initiation according to contact information captured from a display on computer screens.

In some embodiments the distributed telephony system comprises a contact recognition component capable of being installed on end-user communication devices, the devices allowing access to information displayed on a screen, and capable of extracting target contact information from data presented on said screen; a calling media selection component capable of selecting source end-user communication devices and communication IDs, the communication IDs representing target end-user communication devices corresponding with said target contact information; and a call generation component capable of generating connections from said source end-user communication devices to said target end-user communication devices.

In some embodiments the end-user communication devices are selected from a group consisting of: land line phones, cellular phones, IP phones, computers, laptops, smart phones, PDAs, Television sets and tablets.

In some embodiments the connections are selected from a group consisting of: voice communication, video communication, text communication, and combinations thereof.

In some embodiments the communication IDs are selected from a group consisting of: land line phone numbers, cellular phone numbers, chat account IDs, Skype account IDs, social network account IDs (such as Facebook or Twitter and the likes, for example as listed in: http://en.wikipedia.org/wiki/List_of_socia_networking_websites).

In some embodiments the calling media selection component is further capable of consulting with private depositories containing calling media selection preferences.

In some embodiments the calling media selection preferences are selected from a group consisting of: user preferences, group preferences (such as corporate, family or recommended preferences provided by communities or third party services), and combinations thereof.

In some embodiments the calling media selection component is capable of being installed on said end-user communication devices and corporate public branch exchanges (PBXs).

In some embodiments the call generation component is capable of managing direct connections to nearby end-user communication devices.

In some embodiments the call generation component is installed on at least one telephony switching system and/or end user device.

It is another aspect of the invention to provide a method of generating connections from at least one source end-user communication device, the device allowing access to information displayed on a screen and capable of executing a connection generation command to target end-user communication devices, the method comprising: designating data presented on the screen; identifying at least one target contact from said data; selecting at least one communication ID, wherein said communication ID represents at least one target end-user communication device corresponding with said at least one target contact; issuing at least one call generation command to said at least one source end-user communication device; and executing said call from said at least one device.

In some embodiments designating data presented on the screen comprises tracking a pointing device on the screen and selecting data adjacent to said pointing device.

In some embodiments identifying at least one target contact from said data comprises running OCR methods on said data.

In some embodiments identifying at least one target contact from said data comprises consulting with databases containing said at least one communication ID.

In some embodiments selecting at least one communication ID comprises consulting with user preferences, group preferences and combinations thereof.

In some embodiments the preferences comprise optimizing a selection of said communication ID according to criteria consisting of: billing rates, communication line quality, accessibility of a source user to a communication device, availability of a target communication ID, mobility of communication device, and combinations thereof.

In some embodiments issuing at least one call generation command utilizes communication protocols selected from a group comprising: TCP/IP, Bluetooth, Application Programming Interface (API) calls, and combinations thereof.

In some embodiments said designating data presented on the screen comprises selecting data adjacent to said pointing device when said pointing device is stationary for duration longer than a predefined dwell time.

In some embodiments the method is further capable of presenting call history between a plurality of devices associated with a specific user.

In some embodiments said executed call is a text exchange communication.

In some embodiments the method is further capable of intercepting both ingoing and outgoing communication between said source end-user communication device and said target end-user communication device.

In some embodiments the method is further capable of collecting, storing and processing said intercepted communication.

In some embodiments the method is further capable of presenting call history and text exchanged with a specific user.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE FIGURES

For a better understanding of the invention and to show how it may be carried into effect, reference will now be made, purely by way of example, to the accompanying drawings.

With specific reference now to the drawing in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawing making apparent to those skilled in the art how the several forms of the invention may be embodied in practice.

In the accompanying drawings,

FIG. 1A schematically depicts an exemplary typical work environment.

FIG. 1B illustrates additional devices having screens and capable of internet or cellular connectivity to public and private exchanges.

FIG. 2 schematically illustrates the components of an embodiment of a call initiation system consisting of distributed telephony switching and signaling software.

FIG. 3 illustrates a flow chart of a call initiation method 200 based on contact information displayed on a screen.

FIG. 4 illustrates text displayed on a screen, for example a computer screen and the call media selection menu displayed on the same screen.

FIG. 5 schematically depicts another block diagram of a call initiation system.

FIG. 6 schematically depicts a laptop or other mobile computer such as a notepad or a PDA, connected to a mobile phone.

FIG. 7 schematically depicts another embodiment of calling system, similar to the calling system of FIG. 5.

FIG. 8 schematically depicts yet another calling system.

### DETAILED DESCRIPTION OF THE SELECTED EMBODIMENTS

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The terms “comprises”, “comprising”, “includes”, “including”, and “having” together with their conjugates mean “including but not limited to”.

The term “consisting of” has the same meaning as “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

In discussion of the various figures described herein below, like numbers refer to like parts. The drawings are generally not to scale. For clarity, non-essential elements were omitted from some of the drawing.

Embodiments of a system and method to generate connections from public exchanges and personal devices according to contact information displayed on a screen are described hereinbelow. Some embodiments of the system incorporate a unique combination of Telephony-related technologies from different fields, into a complete end-to-end solution which enables a user in communication with a screen showing data representing a target contact, to initiate connections/calls from an optimal source communication device to a contact's optimal target end-user communication device, by designating a relevant region on the screen.

The system operates over the Public Switched Telephone Network (PSTN) and/or any voice, text, video or other human interfacing communication method, like VOIP, Messengers, SMS or Push-To-Talk (PTT) or internet systems. The PSTN substantially allows any two telephone devices in the world to communicate with each other and comprises telephone lines, fiber-optic cables, microwave transmission links, cellular networks, communication satellites and undersea telephone cables, all inter-connected by switching centers and telephony exchanges which enable telephone connection establishment and speech information relay.

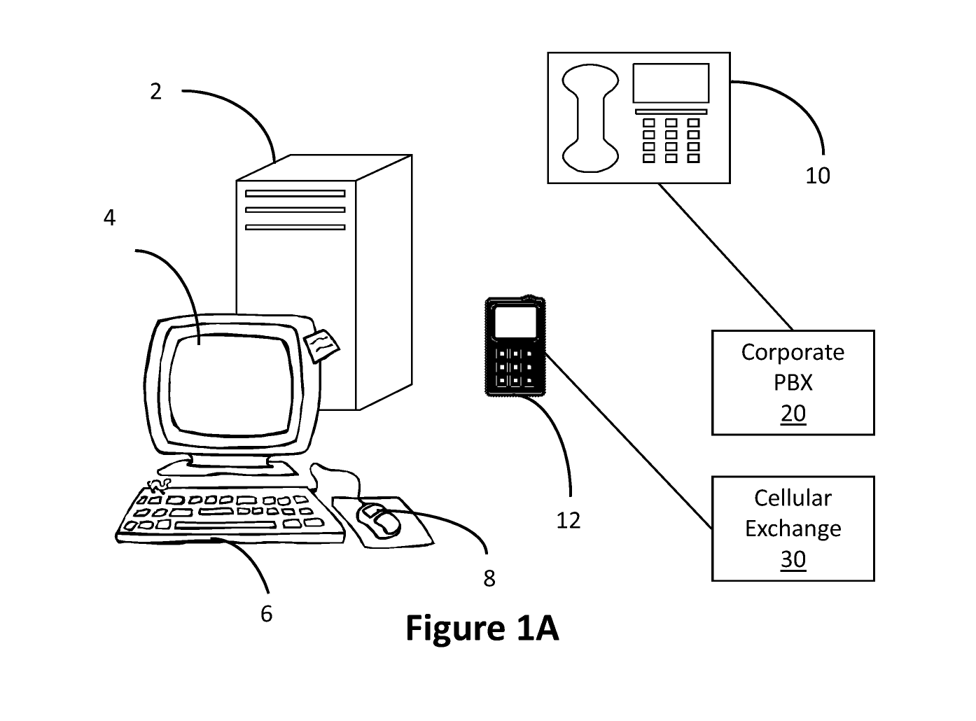

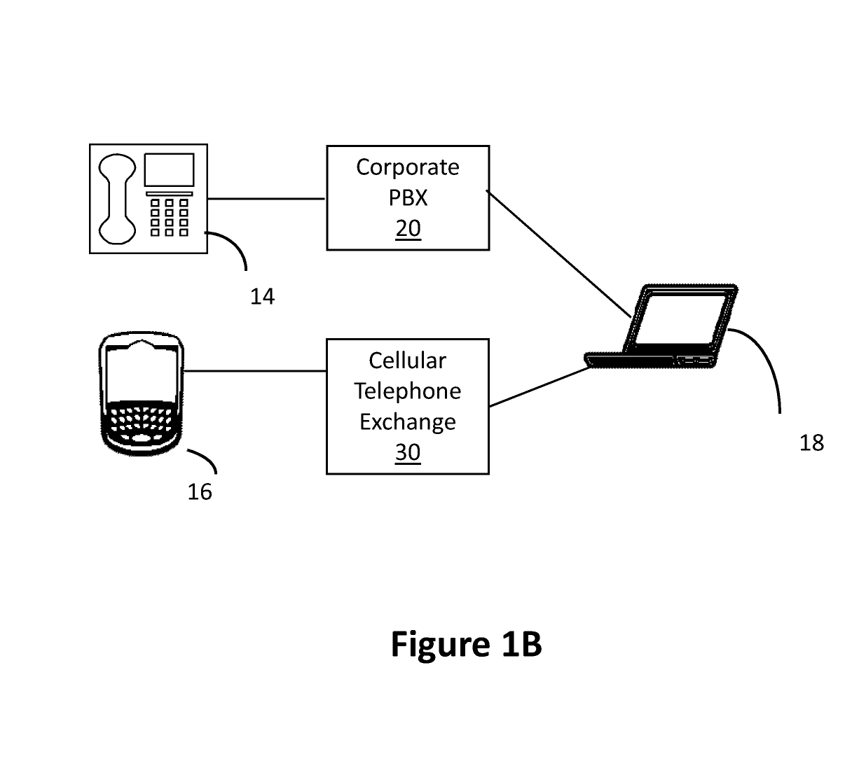

The system aims to serve users with visual access to information displayed on a screen typically positioned in front of them. The screen may be, for example and without limitation, a desktop computer screen, a laptop screen, a Television, a Smart Phone/Personal Digital Assistant (PDA) screen, or tablet computer screen, all of which may be found in typical day to day scenarios such as displayed in FIGS. 1A and 1B.

FIG. 1A schematically depicts an exemplary typical work environment.

The exemplary typical work environment shown in FIG. 1A contains a desktop computer 2 connected to a computer screen 4, a keyboard 6, a pointing device 8 and a desk phone 10. Desk phone 10 is typically connected to a Corporate PBX 20 serving as a central contact point for a plurality of phones within an organization. A user's cell phone 12 is located in the vicinity of the computer screen and shown connected to a Cellular Telephone Exchange (CTE) 30. Not seen in this figure is the connection between PBX 20 and CTE 30 via commonly used infrastructure such as PSTN. Naturally, PBX 20, CTE 30 and PSTN are connected to plurality of end-user devices such as other users' phones and mobile phones.

FIG. 1B illustrates additional communication devices having screens and capable of internet or cellular connectivity to public and private exchanges: IP phone 14 is seen connected to a corporate PBX 20, Smart Phone 16 connected to CTE 30, and laptop 18 which may be connected to a corporate PBX 20 via the intranet when physically located within an organization, or connected via a cellular modem to a telephone exchange, for example and without limitation to CTE 30.

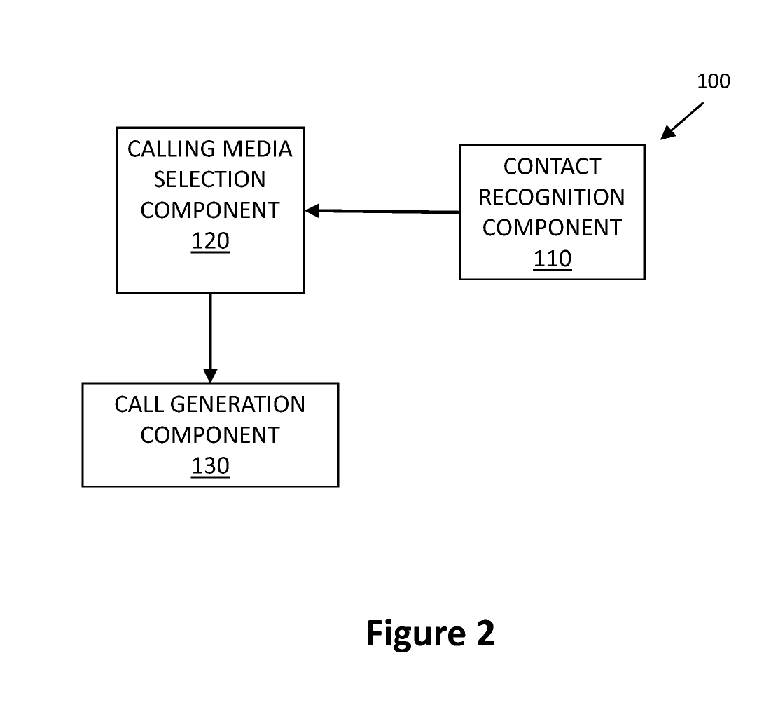

FIG. 2 schematically illustrates the components of an embodiment of a telephony system 100 essentially consisting of distributed telephony switching and signaling components.

The system typically comprises software and/or hardware components installed on telephony exchanges; end-user devices having screens (such as computers); and end-user communication devices.

Contact Recognition Component 110 is installed on the end user device having a screen (such as but not limited to desktop computer 2 of in FIG. 1A, or Smart Phone 16 and laptop 18 in FIG. 1B). The Contact Recognition component 110 is used for recognizing contact information from data presented on a screen and designated by the user. This component is typically capable of tracking a pointing device on a screen, and searching for names and telephone numbers optionally by executing Optical Character Recognition (OCR) algorithms on data presented on the screen adjacent to the pointing device.

The Contact Recognition component 110 is typically capable of consulting with private and/or public address books to determine whether a target contact is already known to the system. Preferably, the Contact Recognition Component is further capable of selecting at least one target communication ID associated with the contact. The term “communication ID” herein may refer to a land line phone number, a cellular phone number, a chat account such as Messenger ID, a Skype account name, a Twitter account ID, or any other communication ID which may be used for identifying a target contact for initiating voice, text, and/or video communication. In some cases, the Contact Recognition component 110 may assist in validating, updating the details (specifically detail such as communication IDs) of an existing contact, or adding a new contact.

A Calling Media Selection Component 120 is typically installed on the end user device and/or the corporate PBX. This component is capable of selecting a source calling media and a target communication ID from a variety of devices and contact options available to a user at real time. This selection is optionally performed by consulting with files and databases describing user and corporate preferences. This component may be capable of searching for the available communication channels by managing direct connections to nearby phone devices, such as IP phones and cellular phones via Bluetooth protocols.

A Call Generation Component 130 is typically installed on the calling media (the end user device) and/or Telephony Exchanges (for example public land line; cellular exchanges; and private corporate branch exchanges). Call Generation component 130 is capable of receiving calling preferences from the Calling Media Selection Component 120; executing call commands according to the calling preferences, thereby initiating phone calls.

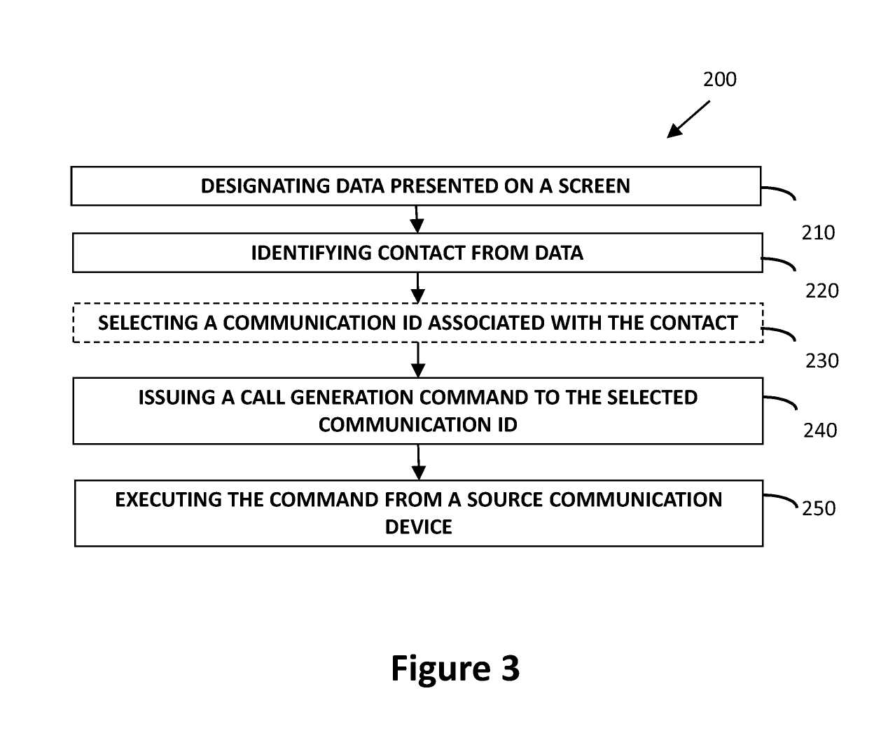

FIG. 3 illustrates a flow chart of a method 200 for generating connections from at least one source end-user communication device based on data displayed on a screen. The method 200 comprises: designating data presented on the screen 210, identifying contact information from the designated data 220, selecting a communication ID 230 (the communication ID representing target end-user communication devices corresponding with the contact information), optionally optimizing the selection according to user and corporate preferences, issuing a call generation command 240, and executing the command from a source end-user communication device 250. Optionally, the method further comprises registration with a service provider.

Registration is typically performed by a user for each communication ID he wished to be associated with. The registration process enables association of a user to his end-user devices and their respective communication IDs in at least one storage server (for example a cloud or a corporate storage server). Registration can be performed for a multitude of end-user devices capable of communication, such as but not limited to desktop computers, laptops, cellular devices or the like. Preferably, registration is performed only once per each device, and the registration details are saved for future use.

In preferred embodiments, end user devices are provided with a ‘client agent’ comprising the components which enable Contact Recognition 110, calling media selection 120 and call generation 130. The ‘client agent’ may be built-in to the device, or retrofitted for example by means of software installation on the device. Once registered, the client agent may send notifications regarding the status of the end-user device, for example and without limitation a status indicating whether the device is open or in use (the line is not available because the user is busy in a call). Data regarding availability may assist calling media selection components 120 of source end-user devices in the selection process of the target calling media.

Designating data presented on a screen 210 by the contact recognition component 110 may be achieved by cursor pointed OCR, enabled by any one or combination of commercial and open-source OCR SDKs, such as but not limited to ReadIRIS, OmniPage, GOCR, and OpenOCR. Selecting an area on the screen on which contact information is displayed may be performed by a pointing device such as, but not limited to a mouse. Additionally or alternatively, when touch screens are used, the user's finger or a stylus may also serve as the pointing device. Designating data presented on a screen may be performed in response to a pointing device resting on the on the screen for longer than a pre-defined time duration. Alternatively, keyboard, mouse or combination of keyboard and mouse actions may be used such as: <En>; “<shift>+<middle mouse click>”, etc. In case of devices without pointing capabilities such as mobile phones or PDAs without touch screen or joystick, or television sets, the contact recognition component may scan the whole screen searching for contact information. Devices that display constantly changing images like Television sets may require constantly scanning the screen or saving the some of the last frames displayed to the user such way that when the user requests to communicate with the displayed contact the system can scan the lately displayed frames and scan them searching for contact information. The contact recognition software may then scan the area surrounding the resting pointing device for elements on the screen which may be interpreted to contact information. Optical Character Recognition (OCR) technology may be utilized to convert data presented in the form of an image (such as scanned documents; images or typewritten text) to machine-encoded text. Parameters such as the pointing device dwell time and/or the breadth of the area for scanning on the screen may be predefined with recommended default values, configurable by a user or combinations thereof.

Identifying contact information from the designated data 220 can be performed according to the designated data which may be in the form of a phone number, a contact name or any other form which suits requirements. The contact recognition component (110 in FIG. 2) may consult with personal databases such as the user's personal contacts, corporate CRM systems, local and network address books, social network lists (such as LinkedIn or Facebook) and combinations thereof. The contact recognition component typically attempts to match the designated data on the screen with contact communication IDs found in private and public databases. In case the contact communication IDs are not found in the databases, the software may attempt to isolate a phone number from the designated data on the screen without matching it to an existing contact in a database. This method can be useful for example when a user searches for a service provider on the internet, and finds the contact information and at least one communication ID of a relevant service provider on a web page. The system may also use location information based on GPS, WiFi Networks, GEO-IP databases or similar services in order to determine the end user location and optimize contact recognition and calling media selection. The contact recognition component 110 may present the contact information to the user. In case the designated data matches multiple contacts, the software may present multiple contacts to a user and possibly suggest a selection among the contacts. Multiple communication IDs (such as a land line number, a cellular number, a Skype ID, or the like) may be available for a single contact, in which case the contact recognition component can present all or selected communication IDs to the user.

Selecting an optimal calling media 230 may be achieved according to configurable preferences. Optionally, the user preferences can be stored on a device connected to the screen from which data was designated, or in a remote location, optionally a corporate data storage. Preferences may be configurable by a user and overridden by corporate preferences when applicable. The optimal calling media (source and target device) and communication ID may be selected according to a variety of criteria such as, but not limited to: pricing; communication line quality; accessibility of a source user to a communication device; availability of a target communication ID; mobility of calling media; or the like. Routing calls by best price may be performed, for example, by cellular adaptors of PBXs, which redirect calls to the most affordable cellular channel available when the target destination is a cellular subscriber. VOIP PBXs may be configured with multiple ‘outbound routes’ having designated providers according to the target destination.

The selection of the optimal calling media may be performed by providing real-time input to a Calling Media Selection Component (120 in FIG. 2). The input may consist of:
The user's present location (country and city area codes).
The types of calling accounts available to the user (mobile, landlines, corporate PBX providers, international calls providers), and the billing rates for each.
The types of devices available to the user for connectivity (desk phones , cell phones, internet connectivity).
The billing rates for the user of each available calling media.
The types of available calling accounts belonging to the target contact.

The Calling Media Selection Software may consider parameters such as but not limited to:
Availability of services and service providers (for example Skype, call back services, etc.). For example, GSM calls intended to a specific cell number in the cellular network may be redirected to a different number, if the cell phone is turned off. This can be performed by setting an alternative destination in the network.
Existence of data exchange connections between the device connected to the screen and the different calling media (for example, internet connection, Bluetooth or the like).
User's preferences and priorities for selection, such as but not limited to lower billing rates, better line quality, or less radiation from the calling media.

The Calling Media Selection Component 120 may execute a selection protocol which may consider the data and parameters mentioned hereinabove. This is demonstrated via a specific, non-limiting example of pricing/billing rates considerations: Assuming that issuing a call from a desk phone is less expensive than a cell phone, if there is an IP connection between the device presenting the target contact information on the screen and the user's desk phone, and a Bluetooth connection between the device and the user's cell phone, the user's desk phone will be selected as the calling media and the target contact's land line number will be selected as the preferred number. Alternatively, if the target contact's cell number can be dialed at reduced rates from the user's cell phone, the cell phone may be selected as the calling media, and the target contact's media selection will be his cell number.

With proper configuration and calling preferences, the calling media may be the destination contact's device. For example, a Calling Media Selection Software 120 installed on a child's home computer, may be capable of communicating with a

Call Generation Software Component 130 installed on a mobile phone belonging to the child's mother. When the child points to a picture representing his mother, the Calling Media Selection Software may designate the mother's mobile phone as the calling media and the home phone as the call destination.

Selecting the optimal calling media may result in “call interception”: For example and without limitation, a user may try to initiate a call from his cellular device despite being located in an environment where a cheaper calling option is available (such as a land line associated with the same user).

In one scenario, an agent component on the user's cellular phone detects that the user is near his home landline phone. This information can optionally be detected when the user's cell connects with the user's home wireless network. The agent may then intercept the outgoing call and suggest making the call via the landline. Optionally, suggestion will be provided according to preferred default options (such as dialing timeouts) which can be pre-configured by the user or by the branch exchange. A telephony exchange may order a call generation command from the optimal calling media available in the user's environment.

In a corporate scenario, an agent component on the user's cellular phone may be made aware that the user is in a branch office of the corporate abroad. Long-distance connection attempts from the user's cellular phone may be intercepted such that the call will eventually be redirected and generated from an alternative calling media, optionally a landline connected with the corporate branch exchange or an alternative calls or callback provider. Criteria for the optimal calling media selection may vary and comprise line availability, billing rates, line quality or the like.

Issuing a call generation command to the optimal calling media 240 is may be performed by the Calling Media Selection Software 120 communicating with a Call Generation Software Component/Application 130 installed on the calling media. The calling media may be end-user devices (desk phones, cell phones) or public telephony switching systems. For example, Asterisk (open source; www.asterisk.org) powers IP PBX systems, VoIP gateways, conference servers and the like to generate calls by creating ‘call files’ describing the desired call information. Public telephony switching systems can issue a call generation command which will appear as if the call was generated by an end-user communication device.

The call may then be initiated from the selected calling media 250 by a Call Generation Application. The call command can be issued locally from the device on which the Call Generation application is running, or remotely from a different device in the network. For example, when an end-user calling device is connected to a PBX via a TCP/IP network, an application running on the end-user calling device can use the Asterisk software to initiate a call from another device using a different landline, cellular line, or IP communication channel.

It is possible that a call cannot be established from either of the user's or the target's available calling media, for example when the media is already busy with another call. In such a case, the Calling Media Selection Component 120 may communicate with a Call Generation Software Component 130 installed on a telephony switching system. The telephony switching system may detect when the calling devices of the caller and the target are available, initiate two calls to the two devices and merge both calls into a single call. Both calls may be initiated simultaneously. Alternatively, only when a first call is answered, another call is made from the switching system to a target device and the calls are connected into a single call. Optionally, the caller's ID and/or a voice message may be issued to either party.

Multi operator/network interoperability may be enabled via the Public Switched Telephone Network (PSTN). When a subscriber of one operator calls a subscriber of another operator, a connection is created between the two operators. The connection enables transfer of voice, text or video between the operators. Each operator is responsible for transferring the voice/video stream between the connection and its subscriber endpoint. Alternatively, the system may bridge between different operators by interconnecting them via other networks such as the Internet, and reduce the communication costs to the user.

In preferred embodiments, the system is capable of intercepting both ingoing and outgoing communication. For example, incoming SMS interception may enable a user to use his PC for text communication (SMS) allowing a chat-like experience. Outgoing messages generated by the user are sent on his behalf from the original communication device, an operator, or a service provider serving as an SMS server. Incoming messages to the user's device may also be intercepted, such that even thought they are sent to the user's cell phone the messages will be displayed on other devices, for example the user's PC. The option to receive the message on more than one end-user communication device may also be available, allowing users to track text communication on a plurality of communication devices.

Incoming message interception is enabled by a mobile agent on devices which allow interception (such as Google Android), or alternatively by the operator's SMS center when the device does not allow the interception (such as Apple iPhone). Configuration of incoming interception typically includes a request made from the server to the agent on the user's device of to the SMS Center, specifying the source and/or target IDs which should be followed.

Additionally, the system may be capable of intercepting the reply messages and send them to the ‘call generating’ device, for example, the PC from which the user typed his message. This interception may be done by the mobile agent, if the Operating System (OS) supports it, or by the operator's SMS Center (SMSC) otherwise. For example, Android supports SMS interception on the device, iPhone and other devices don't support it at this time. The interception may be requested from the server to the agent or SMSC, specifying the source and/or target calling IDs to follow.

Additionally or optionally, the system may enable sharing call history between a plurality of devices associated with a specific user.

In preferred embodiments, a server may be capable of collecting call/SMS history from various devices (PC, landline, mobile devices) and from the communication operator. Once identified, a call history for a contact can be displayed. Optionally, the agent on an end-user device can allow call history display and search, allowing for quick and easy re-connection of previous sessions.

Additionally or optionally, the system at whole may be capable of allowing the sharing of call history between the various devices. For example:
The server may collect call/SMS history from the devices (such as a PC or a mobile) and possibly from the communication operator.
When a contact is identified, the call history, associated with this contact may be displayed.
The PC agent may allow showing and searching the call history, allowing easy re-connection of previous sessions.

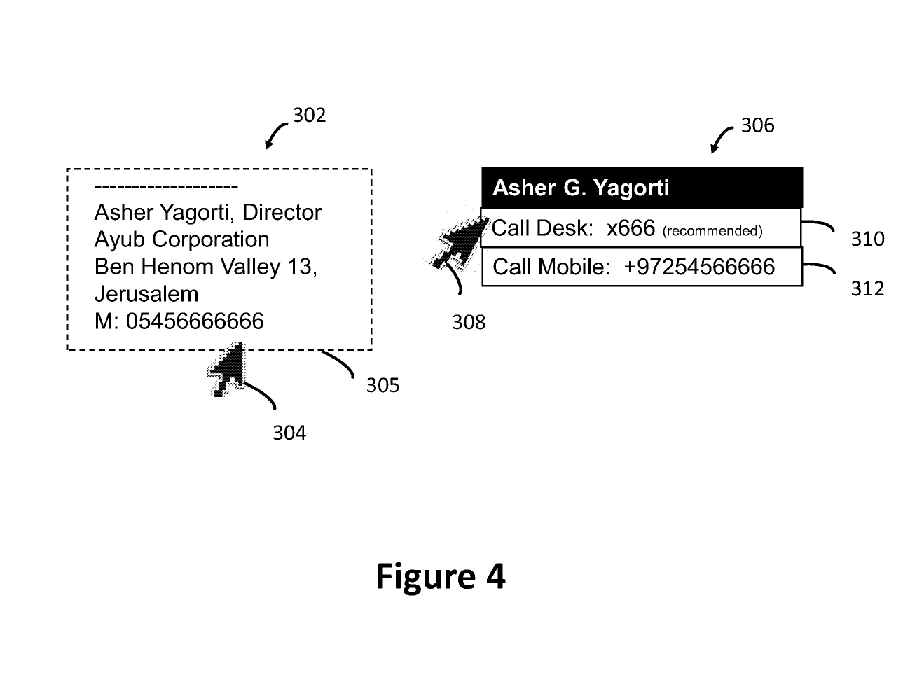

FIG. 4 illustrates text displayed on a screen, for example a computer screen and the call media selection menu displayed on the same screen.

Text 302 representing a contact that is pointed to by cursor 304. Optionally, cursor 304 may be placed above text 302. A Contact Recognition Agent (Contact Recognition Software Component 110 of FIG. 2) tracks the cursor movements using standard APIs (Application Programming Interface) and system calls such as but not limited to SetWindowsHookEx in Windows. Once Contact Recognition Agent 310 detects that the cursor has stopped, it scans the display memory area 305 surrounding cursor 304. Scanning is optionally performed by recording the last known cursor position, copying an image from the screen area surrounding the cursor position, and running an OCR engine on the image.

Any of a family of algorithms for moving and copying rectangles of bits between main and display memory on a bit-mapped device, or between two areas of either main or display memory may be used for copying the image from the screen area surrounding the cursor. One sample algorithm may be Bit'Blit. The OCR engine may be, for example and without limitation, Tesseract.

In the example above, the text ‘05456666666’ is found in the scanned image and detected as Mobile number. A Corporate Directory Service or alternative address books may be consulted in order to identify the contact. In this example, the contact ‘Asher G. Yagorti’ is found.

In an exemplary embodiment, when a potential contact is identified under the cursor, the User Interface (UI) appears less than one second after the mouse stops moving. For example, the preferred option is positioned in proximity to the mouse location, for example right under the mouse, so most cases, when the user is interested with initiating a call, a single mouse click would initiate the call.

In an exemplary embodiment, moving the mouse outside the UI will make the UI immediately disappear, allowing the user to easily closing it without the need for pressing the mouse.

In an exemplary embodiment, the mobile agent may be used (according to the mobile OS support) also for publishing the user's availability for mobile calls (online/offline/busy) which can be reflected on the desktop/mobile agent UI.

In an exemplary embodiment, the Personal Assistant (PA) may initiate a call from another employee's phone to a requested number. For example: a salesperson ‘Bob’ driving his car, asks his PA or a colleague to connect him with the customer that emailed a question this morning. The PA finds the email, puts the mouse over the customer's phone number and when the UI pops up it requests to initiate the call from Bob's mobile.

A Calling Media Selection component (120 in FIG. 2) may query for presence information about ‘Asher’. If a positive presence indication is received, the Calling Media Selection component may compare available calling media according to parameters such as call prices and line quality. For example, it may compare the options of calling Asher's mobile number vs. calling his desk extension. In this example, the desk extension is chosen as a default option, and the mobile number as a second option. A call selection menu 306 may then appear, with the default option 310 pointed to by cursor 308, enabling a user to initiate a call in a single click or push of a button without moving the cursor by a pointing device such as a mouse.

If the user clicks on ‘Call Desk’ option 310, the Call Generation Agent (130 in FIG. 2) requests the PBX generate a call to the user's desk phone and to the target contact's (Asher's) desk phone. Alternatively, if the user selects the ‘Call Mobile’ option 312, Call Generation Agent (130 in FIG. 2) requests the PBX to create a call to the user's desk and to the target contact's (Asher's) cell phone.

Requests may be made by the Call Generation Agent 130 directly to the PBX, or to a corporate server which instructs the PBX to generate calls to the specified destination. Call Generation Agent 130 may be connected to a plurality of servers, optionally belonging to different communication operators/providers. Agent 130 may perform a bid between the different servers, choose the server/operator offering the best call condition according to the user preferences, and request the selected server to generate the calls which can later be interconnected into a single call.

Optionally, the selected source calling media (the user's desk phone or cell phone, for instance) may be connected to a computer network via wired or wireless connection (Bluetooth, RS232, USB or any other connection methods and protocols which suit requirements). When Call generation Agent 130 is installed on the calling media, for example an end-user device such as a cell phone, the agent may initiate a call command directly from the calling media without a mediating server/operator.

The call command may have any format which suits requirements, for example and without limitation:

ATD+9725456666—(Dial) command to the cell phone

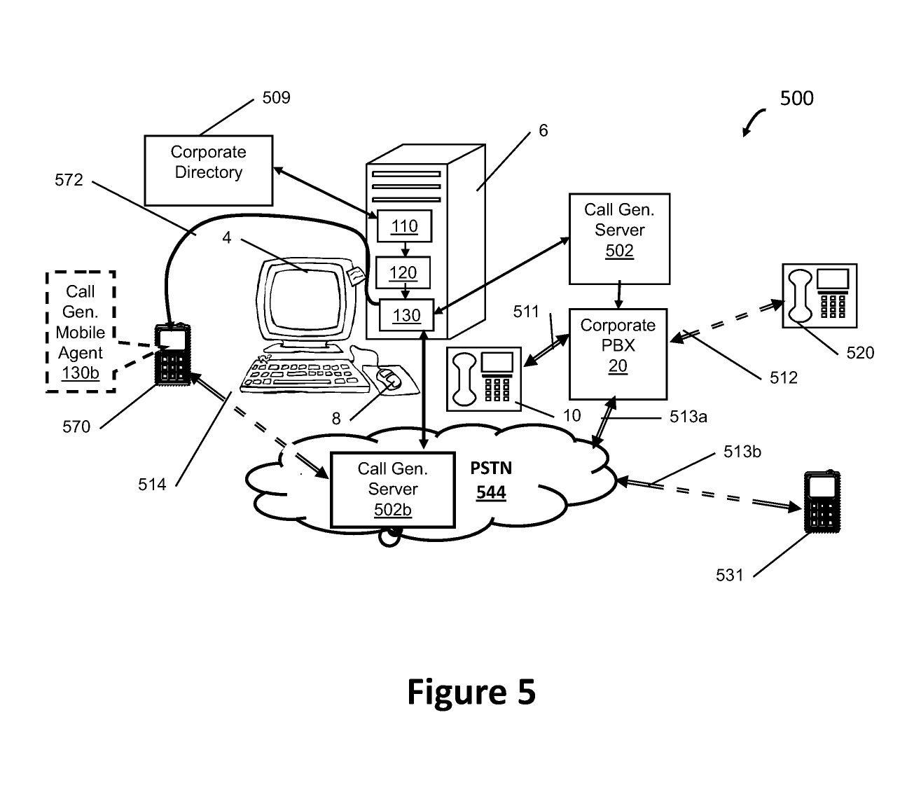

FIG. 5 schematically depicts another block diagram of a call initiation system 500.

System 500 is capable of performing a method of call initiation 200 substantially as depicted in FIG. 3.

Refereeing back to FIGS. 4, and assuming that text 302 is displayed on the display 4 of the computer 6, and the mouse 8 was used to place the cursor 304 above or near the phone number (0546666666). A short time after the cursor 304 was placed above the number, the contact recognition component 110, installed in computer 6, tracking the mouse movement with a system call like SetWindowsHookEx in Windows, detects that the mouse has stopped moving for a predetermined dwell period. The contact recognition component 110 scans the display memory around the cursor by taking the last known mouse position, copying an image from the screen area around the cursor position using a system function like Bitblt in Windows, and running OCR engine like Tesseract on the image.

In the example above, the text ‘05456666666’ is found in the scanned image and recognized as Mobile number. An optional Corporate Directory 509 service may be consulted as well as other network address books or address books installed on the computer 6, and in this case the contact ‘Asher G. Yagorti’ is found. Corporate Directory 509 may be locally stored in computer 6 or remotely stored on a corporate server.

In the depicted scenario, the Call Generation Agent 130 queries the Call Generation Server 502 for presence information about ‘Asher’, and gets positive answer. The Call Generation Agent 130 then compares call prices and qualities of calling Asher's mobile number vs. calling his extension, and chooses the ‘Desk’ extension as a default option, and the mobile option as a second option. The call selection menu (306 of FIG. 4) appears with the default option 310 appears right under the cursor 308, allowing making the default call in a single click without moving the mouse.

When the user clicks on ‘Call Desk:’ 310, the Call Generation Agent 130 requests the Call generation Server 502 to instruct the Corporate PBX 20 to generate a call 511 to the user desk phone 10 and a call 512 to Asher's desk phone 520.

If, however, the user clicks ‘Call Mobile:’ option 312, the Call Generation Agent 130 requests the corporate server 20 to instruct the PBX to create a call 510 to the user's desk phone 10 and a call 513 Asher's cell phone 531. Call 513 is routed via PSTN 544. Call 513 may comprise a plurality of sections such as 513a and 513b and involves subsystems such as land line and cellular switches, relays and RF base-station antennas.

Call Generation Agent 130 may optionally be connected to one or more additional Call Generation Servers 502b located at communication providers locations and schematically depicted as part of the communication infrastructure external to the corporation (PSTN 544). Call Generation Agent 130 may perform a bid between the different additional Call Generation Servers 502b; choose the server/operator offering the best call condition according to the user preferences; and request the selected additional Call Generation Servers 502b to generate a call 514 to the user's cell phone 570 and a call 513b to Asher's cell phone 531; and then interconnect the two calls 513b and 514 together.

Optionally, if the user's cell phone 570 is connected to the computer 6 with a wired or wireless connection 572 such as Bluetooth, RS232 or USB, or if an optional Call Generation Mobile Agent 130b is installed on the user's cell phone 570, and the Call Generation Mobile Agent 130b is connected via a network connection to a Call Generation Server 130 or additional Call Generation Servers 502b, the mobile call can may be generated directly from the user's cell phone 570 to Asher's cell phone 531 using the cellular communication infrastructure (depicted here as PSTN 544).

To commence a call from the user's cell phone 570 to Asher's cell phone 531, via a connection between the computer 6 and user's cell phone 570, Call Generation Server 130 communicate a dial command to user's cell phone 570. For example, Call Generation Server 130 may use the cell phone's modem connection to send the command “ATD+9725456666 (Dial)” to the user's cell phone 570. Using the optional Call Generation Mobile Agent 130b, Call Generation Server 502 or additional Call Generation Server 502b, having an active network connection with the Call Generation Mobile Agent 130b, may send the dial command to the Call Generation Mobile Agent 130b, and the Call Generation Mobile Agent 130b requests the cell phone 570 to dial to the destination mobile phone 531 with method such as platform Request(‘tel:+97254566666’) in Java.

It is clear to see that the user's cell phone 570 may generate calls to a non-mobile destination in the same manner using the communication infrastructure (PSTN 544).

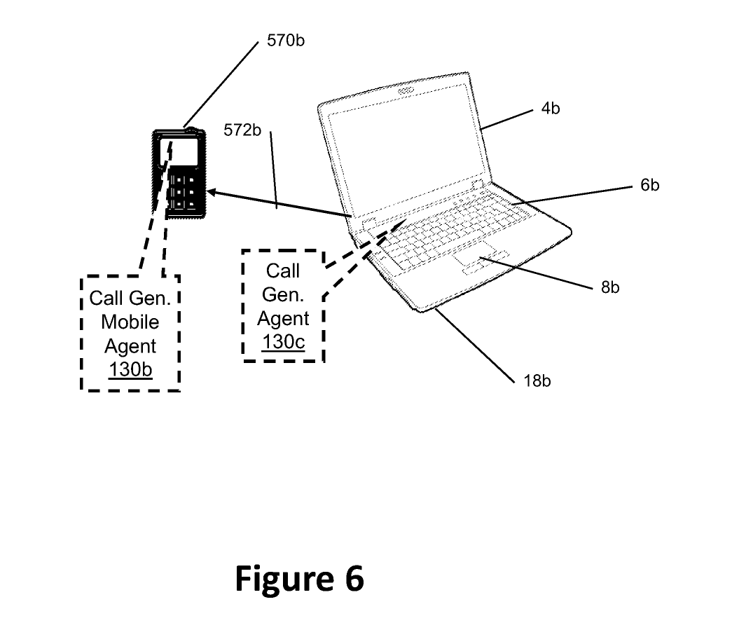

FIG. 6 schematically depicts a laptop or other mobile computer such as a notepad, Tablet, Smart phone or a PDA, connected to a mobile phone.

laptop 18b may have no network connectivity of any type to corporate PBX 20 or to cellular exchange 30, but be connected to cellular phone 570 by wired or wireless communication channel 572b (for example USB or Bluetooth). In this case, the lack of connectivity prevents a Call Generation Component Agent 130c installed in laptop 18b from consulting a corporate directory directly. However, Call Generation Component Agent 130c may still consult with local address books or locally cached copies of the corporate directory stored in laptop 18b.

Designation of target communication ID (302 in FIG. 4), and selection of call options (306 in FIG. 4) are performed using the laptop's screen 4b; pointing device 8b and optionally the keyboard 6b as already disclosed. Optionally, additionally or alternatively, touch-screen may be used.

When the user selects the desired destination, the Call Generation Agent 130c sends a dial (ATD) command to the Call Generation Mobile Agent 130b user's mobile phone 570b with the destination number, causing a call to be generated directly from the cell phone to the destination.

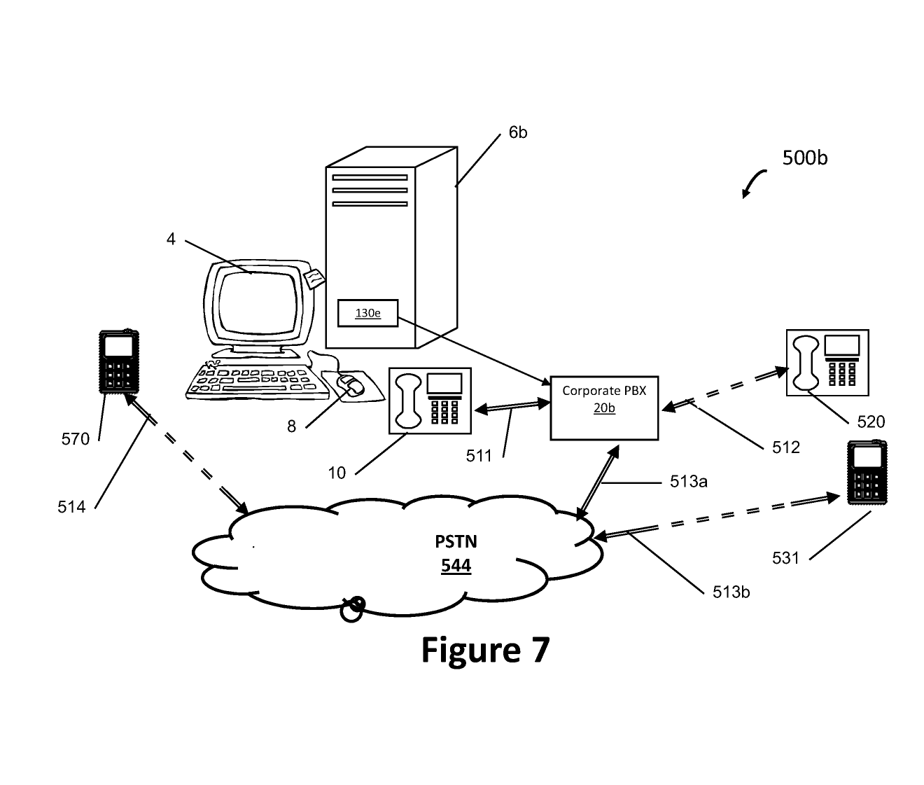

FIG. 7 schematically depicts another embodiment of calling system 500b, similar to the calling system 500 of FIG. 5.

In this configuration, a different type of the Call Generation Agent 130e is installed on the computer 6b, which allows direct connection to one ore more PBXes 20b, and the process remains similar to the already disclosed process, but without using a call generation server.

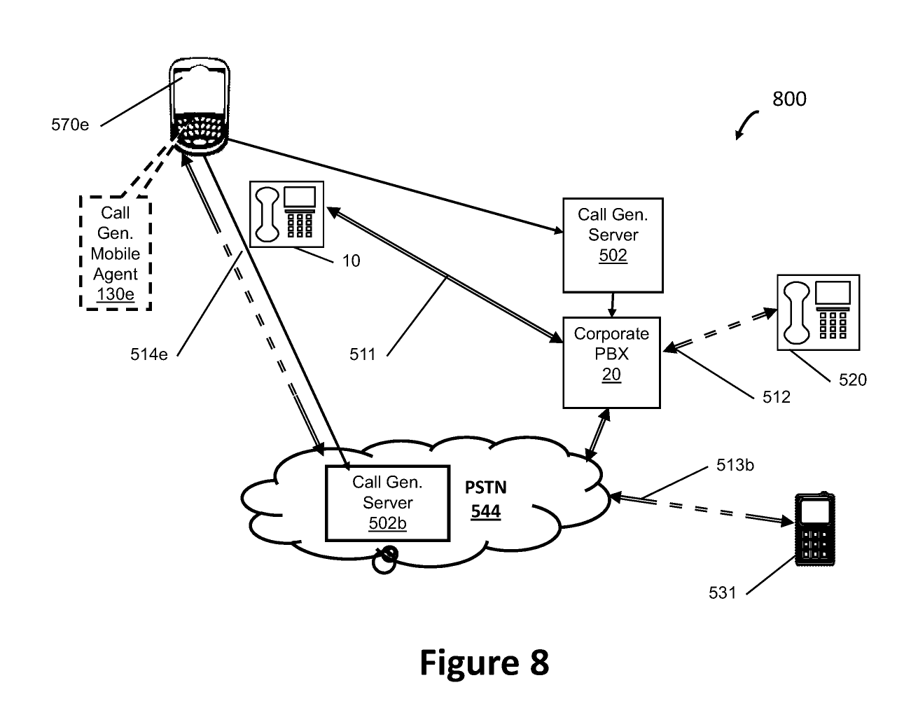

FIG. 8 schematically depicts yet another calling system 800.

In calling system 800, the Call Generation Mobile Agent 130e installed in and executed by runs on a user's cell phone 570e if the Operation System (OS) of cell phone 570e allows installation of a third party software that can run in the background and perform contact recognition when applicable. Call Generation Mobile Agent 130e detects cursor movements or touch-screen hits and grabs the image around the desired screen location. Designation of the target ID, Identification of the target ID; and selection of calling media is performed in a process similar to the process already depicted.

In cell phones that do not allow installing functionality similar to the one possible on the computer, one or more of the following methods to initiate a call may be used:
The Call Generation Mobile Agent may include an option to initiate a call by selecting a contact from the cell phone's contacts list, typing a number or selecting a contact from the user's call history. The contacts list can be retrieved from the device OS via a call like Java's openPIMList
The Call Generation Mobile Agent registers itself with the operating system or tracks the phone activity, such way that whenever a number is dialed or about to be dialed, a text/multimedia message is sent or is about to be sent by the user from the contact book or other phone applications, the agent is alerted

User's cell phone 570e may initiate the call to the destination using one of the optional method:
Call Generation Mobile Agent 130e may initiate a cellular call to the destination, for example cellular phone 531 (other destinations such as line phone may be called) using infrastructure 544.
Call Generation Mobile Agent 130e may initiate a call to the destination by communicating with Call Generation Server 502, located in the corporation site.
Call Generation Mobile Agent 130e may initiate a bid for the call to the destination by communicating with Additional Call Generation Servers 502b, located in communication provider sites.

Communication with Additional Call Generation Servers 502b and/or with corporate Call Generation Servers 502 may be achieved for example by exchanging SMS messages; by using short range communication channel such as Bluetooth or Wi-Fi to a close-by wireless hub; or by using Internet facilities provided by the cellular operator infrastructure.

The rest of the calling process, initiated by Additional Call Generation Servers 502b and/or with corporate Call Generation Servers 502 is performed as already disclosed before.

In some embodiments of the invention the system may perform presence checking and bidding, and performing of presence checking and bidding, may be distributed across multiple servers and devices.

In some embodiments of the invention contact recognition may also use picture identification methods and services.

It should be noted that the term “call” or “connection” is to be generalized to include other communication means such as: voice call; video call; Internet voice or voice and video call such as “Skype” or other “over the Internet” calls; text connections, such as but not limited to computer chats such as “IM” or other “over the Internet” chats; etc.

As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects.

Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A distributed telephony system comprising:
a contact recognition component capable of being installed on end-user communication devices allowing access to information displayed on a screen, and capable of extracting target contact information from data presented on said screen, and communicating information indicative of said extracted target contact information to a calling media selection component;
a calling media selection component capable of selecting at least one source end-user communication devices and communication IDs, wherein said communication IDs representing target end-user communication devices corresponding with said extracted target contact information; and
a call generation component capable of generating connections from said selected source end-user communication devices to said target end-user communication devices.

2. The system of claim 1, wherein said end-user communication devices are selected from a group consisting of: land line phones, cellular phones, IP phones, computers, laptops, smart phones, PDAs, Television sets and tablets.

3. The system of claim 1, wherein said connections are selected from a group consisting of: voice communication, video communication, text communication, and combinations thereof.

4. The system of claim 1, wherein said communication IDs are selected from a group consisting of: land line phone numbers, cellular phone numbers, chat account IDs, Skype account IDs, social network account IDs.

5. The system of claim 1, wherein said calling media selection component is further capable of consulting with private depositories containing calling media selection preferences.

6. The system of claim 5, wherein said calling media selection preferences are selected from a group consisting of: user preferences, group preferences (such as corporate, family or recommended preferences provided by communities or third party services), and combinations thereof.

7. The system of claim 1, wherein said calling media selection component is capable of being installed on said end-user communication devices and corporate public branch exchanges (PBXs).

8. The system of claim 1, wherein said call generation component is capable of managing direct connections to nearby end-user communication devices.

9. (canceled)

10. (canceled)

11. A method of generating connections from at least one source end-user communication device, said device allowing access to information displayed on a screen and capable of executing a connection generation command to target end-user communication devices, the method comprising:
designating data presented on the screen;
identifying at least one target contact from said data;
selecting at least one communication ID, wherein said communication ID represents at least one target end-user communication device corresponding with said at least one target contact;
issuing at least one call generation command to said at least one source end-user communication device; and
executing said call from said at least one device.

12. The method of claim 11, wherein said designating data presented on the screen comprises tracking a pointing device on the screen and selecting data adjacent to said pointing device.

13. The method of claim 11, wherein said identifying at least one target contact from said data comprises at least one of executing OCR software on said data or consulting with databases containing said at least one communication ID.

14. (canceled)

15. The method of claim 11, wherein said selecting at least one communication ID comprises consulting with user preferences, group preferences and combinations thereof.

16. The method of claim 15, wherein said preferences comprise optimizing a selection of said communication ID according to criteria consisting of: billing rates, communication line quality, accessibility of a source user to a communication device, availability of a target communication ID, mobility of communication device, and combinations thereof.

17. The method of claim 11, wherein issuing at least one call generation command further comprises intercepting call generation commands issued from at least one end-user communication device.

18. (canceled)

19. The method of claim 12, wherein said designating data presented on the screen comprises selecting data adjacent to said pointing device when said pointing device is stationary for duration longer than a predefined dwell time.

20. The method of claim 11, further capable of presenting call history between a plurality of devices associated with a specific user.

21. The method of claim 11, wherein said executed call is a text exchange communication.

22. The method of claim 21, further capable of intercepting both ingoing and outgoing communication between said source end-user communication device and said target end-user communication device.

23. The method of claim 22, further capable of collecting, storing and processing said intercepted communication.

24. (canceled)
